(19) United States
(12) Patent Application Publication
(10) Pub. No.: US 2023/0368019 A1
(43) Pub. Date: Nov. 16, 2023

(54) DEEP LEARNING SYSTEM FOR PERFORMING PRIVATE INFERENCE AND OPERATING METHOD THEREOF

(71) Applicant: Samsung Electronics Co., Ltd., Suwon-si (KR)

(72) Inventors: Hongrak SON, Anyang-si (KR); Jaiyoung PARK, Seoul (KR); Jungho AHN, Seoul (KR); Youngsik MOON, Suwon-si (KR)

(73) Assignees: Samsung Electronics Co., Ltd., Suwon-si (KR); Seoul National University R&DB Foundation, Seoul (KR)

(21) Appl. No.: 18/063,323

(22) Filed: Dec. 8, 2022

(30) Foreign Application Priority Data
May 12, 2022 (KR) 10-2022-0058231
Jul. 7, 2022 (KR) 10-2022-0083556

(51) Int. Cl. G06N 3/08; G06N 5/04

(52) U.S. Cl. CPC G06N 3/08; G06N 5/04

(57) ABSTRACT

A method of operating a deep learning system configured to perform private inferences, including performing a convolution operation with respect to input values; and outputting result values from the convolution operation using an activation function, wherein the activation function includes a Hermitic expansion using a Hermite polynomial as an eigenfunction to perform a Fourier transform.

### CROSS-REFERENCE TO RELATED APPLICATION(S)

This application claims benefit of priority to Korean Patent Application No. 10-2022-0058231 filed on May 12, 2022 and Korean Patent Application No. 10-2022-0083556 filed on Jul. 7, 2022 in the Korean Intellectual Property Office, the disclosures of which are incorporated herein by reference in their entirety.

### BACKGROUND

The present inventive concepts relate to a deep learning system for performing private inferences and an operating method thereof.

In general, Machine Learning as a Service (MLaaS) may refer to designing, implementing, and distributing a machine learning model continuously providing a machine learning service to a user. In cases wherein privacy-sensitive information, such as a medical image, genetic information, and financial status of the user are involved, sending the information to a cloud is often prohibited by law (GDPR, HIPAA, and the like). Therefore, information about the machine learning model should be protected from an external security attack. In this situation, a private inference protecting privacy will be used to transform the machine learning model into MLaaS.

### SUMMARY

An aspect of the present inventive concepts is to provide a deep learning system for performing a novel private inference and an operating method thereof.

According to an aspect of the present inventive concepts, a method of operating a deep learning system including a convolution neural network (CNN) trained to perform a private inference, includes inputting encrypted input values to the CNN; performing a convolution operation with respect to the encrypted input values; and outputting result values from the convolution operation based on a determination using an activation function, wherein the activation function includes a Hermitic expansion using a Hermite polynomial as an eigenfunction to perform a Fourier transform.

According to an aspect of the present inventive concepts, a deep learning system for performing a private inference, includes a client device configured to pre-calculate randomly generated data; and a cloud server configured to receive the pre-calculated data from the client device, to generate operated values by performing a homomorphic encryption operation with respect to the received pre-calculated data, and to output the operated values based on determination using an activation function, wherein the activation function includes a Hermitic expansion using a Hermite polynomial as an eigenfunction to perform a Fourier transform.

According to an aspect of the present inventive concepts, a method of operating a deep learning system, includes collecting data; training a prediction model based on the collected data; and performing private inference using the prediction model, wherein the private inference includes a homomorphic encryption operation and a multi-party computation, and wherein the multi-party computation includes using an activation function includes a Hermitic expansion using a Hermite polynomial as an eigenfunction to perform a Fourier transform.

According to an aspect of the present inventive concepts, a deep learning system includes an offline deep learning system; and an online deep learning system, wherein each of the offline deep learning system and the online deep learning system are trained to perform a convolution action, and to output operation values of the convolution action based on a polynomial activation function, and wherein the polynomial activation function includes a Hermitic expansion using a Hermite polynomial as an eigenfunction to perform a Fourier transform.

### BRIEF DESCRIPTION OF DRAWINGS

The above and other aspects, features, and advantages of the present inventive concepts will be more clearly understood from the following detailed description, taken in conjunction with the accompanying drawings, in which:

FIG. 1 is a view illustrating a deep learning system for protecting privacy according to at least one example embodiment.

FIG. 2 is a view illustrating a private inference S3 according to at least one example embodiment.

FIG. 3 is a view illustrating a homomorphic encryption system 10 according to at least one example embodiment.

FIG. 4 is a view illustrating a structure of a network system for performing a multi-party computation according to at least one example embodiment.

FIG. 5A is a view illustrating a Hermite polynomial (“HerPN”) activation function combining Hermitic expansion and basis-wise batch normalization, and FIG. 5B is a view illustrating Hermite polynomial graphs up to a third (3^{rd}) order Hermite polynomial.

FIG. 6A is a view illustrating a network using ReLU in ResNet, and FIG. 6B is a view illustrating a network using HerPN in ResNet.

FIG. 7A is a view illustrating a network using ReLU in Preactivation ResNet (PA-ResNet), and FIG. 7B is a view illustrating a network using HerPN in PA-ResNet.

FIG. 8A is a view illustrating a network using ReLU in VGG, and FIG. 8B is a view illustrating a network using HerPN in VGG.

FIG. 9 is a view illustrating a privacy deep learning system 100 according to at least one example embodiment.

FIG. 10 is a flowchart illustrating an operating method of a deep learning system according to at least one example embodiment.

FIG. 11 is a view illustrating classification accuracy of ReLU and HerPN in a deep learning CNN model according to at least one example embodiment.

FIG. 12 is a view illustrating a storage device 500 according to at least one example embodiment.

FIG. 13 is a view illustrating an electronic device 1000 to which a storage device according to at least one example embodiment is applied.

### DETAILED DESCRIPTION

Various example embodiments will be described more fully hereinafter with reference to the accompanying drawings, in which some example embodiments are shown. In the drawings, like numerals refer to like elements throughout. The repeated descriptions may be omitted.

In this disclosure, the functional blocks may, unless expressly indicated otherwise, denote elements that process (and/or perform) at least one function or operation and may be included in and/or implemented as processing circuitry such hardware, software, or the combination of hardware and software. For example, the processing circuitry more specifically may include (and/or be included in), but is not limited to, a processor, a Central Processing Unit (CPU), a controller, an Arithmetic Logic Unit (ALU), a digital signal processor, a microcomputer, a Field Programmable Gate Array (FPGA), a System-on-Chip (SoC), a programmable logic unit, a microprocessor, Application-specific Integrated Circuit (ASIC), semiconductor elements in an integrated circuit, circuits enrolled as an Intellectual Property (IP), etc. In some example embodiments, the processing circuitry may include computer-readable program code stored in a computer-readable medium. The computer-readable program code may be provided to a variety of computers or processors of data processing devices. The computer readable media may be, for example, a non-transitory computer readable media. The term “non-transitory,” as used herein, is a description of the medium itself (e.g., as tangible, and not a signal) as opposed to a limitation on data storage persistency (e.g., RAM vs. ROM). For example, the computer-readable recording medium may be any tangible medium that can store or include the program in or connected to an instruction execution system, equipment, or device.

Hereinafter, the present inventive concepts will be described clearly and in detail to the extent that a person skilled in the art easily implements the same using the drawings.

In general, a machine-learning-as-a-service (MLaaS) may use deep learning technology for predictive analytics to improve decisions. However, the MlaaS may pose data privacy concerns for a data owner (e.g., a client) and security concerns for a deep learning model owner (e.g., a service provider). Therefore, protecting privacy with regards to deep learning is often required.

A deep learning system and an operating method thereof, according to at least one example embodiment, may protect privacy by performing a private inference (PI) for performing homomorphic encryption (‘HE’) and multi-party computation (‘MPC’). In particular, the private inference according to at least one example embodiment may be implemented using a polynomial activation function using Hermitic expansion. The private inference of the present inventive concepts may use such a polynomial activation function for the multi-party computation, to greatly reduce a cost of a multiplication operation (e.g., an operation execution time, an amount of network communication, and/or the like).

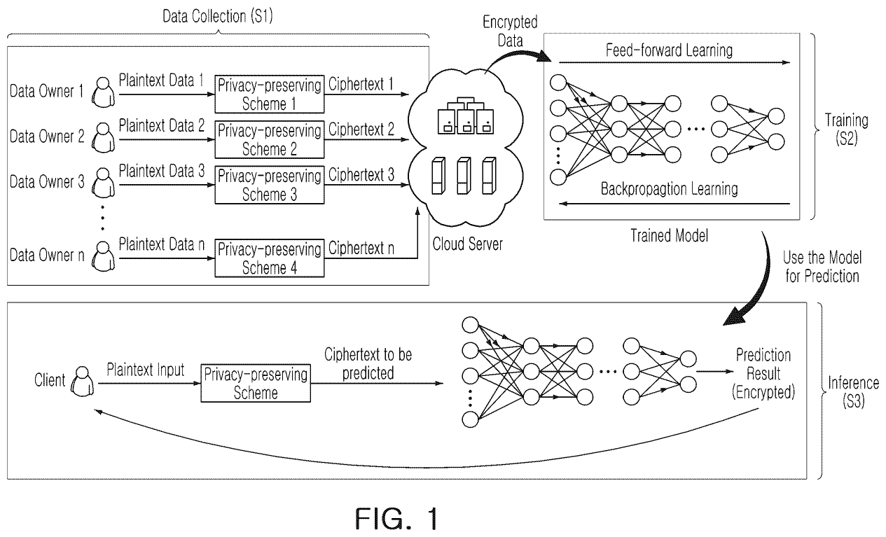

FIG. 1 is a view illustrating a deep learning system for protecting privacy according to at least one example embodiment. Referring to FIG. 1, operation of a privacy deep learning system may be largely divided into data collection S1, training S2, and inference S3.

In at least one embodiment, in the data collection S1, data such as plaintext data may be encrypted to securely transmit the data from a data owner to a cloud. For example, the encrypted data may be sent to a cloud server.

In at least one embodiment, in the training S2, the encrypted data may be used as an input of a deep learning model. A training process may be divided into feed-forward learning and backpropagation learning. The feed-forward learning may train the model, and the backpropagation learning may minimize an error in training. In at least one embodiment, the training S2 may be based on supervised learning, (e.g., a method of analyzing or extracting data characteristics of input data with label information and may utilize a neural network structure by learning (or training) based on the input data with label information to generate prediction models) and/or unsupervised learning (e.g., a method of analyzing or extracting data characteristics of input data without label information, which may utilize, e.g., an autoencoder (AE) structure).

In the inference S3, a client may transmit a query (e.g., corresponding to a prediction target) to the cloud server. The cloud server may receive the query, and may output a prediction result to the client, using a trained prediction model. In at least one embodiment, the inference S3 may be and/or use a private inference (PI). In general, the private inference (PI) may refer to a set of techniques that enable inference with the machine learning, without a need to disclose personal data of a client to a service provider and/or without a need to disclose a trained model of the service provider to the client.

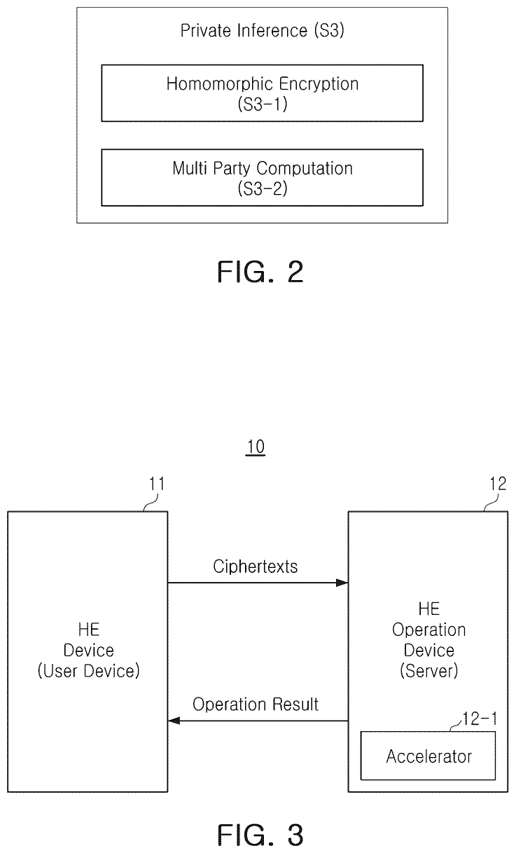

FIG. 2 is a view illustrating a private inference S3 according to at least one example embodiment. Referring to FIG. 2, a private inference S3 may encrypt data using homomorphic encryption S3-1 and a multi-party computation S3-2.

The private inference S3 may selectively use homomorphic encryption and/or a multi-party computation for each framework, when performing an operation for an activation function of a machine learning model. The present inventive concepts may be applicable to both cases of using homomorphic encryption (HE) or a multi-party computation (MPC). The present inventive concepts may be broadly applicable to almost all frameworks.

The present inventive concepts may replace an activation function such as a rectified linear unit (ReLU), which causes a bottleneck in private s (PI) protecting privacy, with a polynomial-based linear function, to reduce an overall execution time period and an amount of network communication. In at least some embodiments, when the present inventive concepts use a polynomial-based activation function, it is possible to obtain classification accuracy, equivalent to that of an activation function commonly used in image classification training, while optimizing performance and costs of private inferences protecting privacy.

In general, private inferences (PI) may be a technology enabling machine learning as a service while protecting privacy data of a service user, and a machine learning model of a service provider, which may be an intellectual property right, from disclosing the same. In the PI, when the machine learning model of the service provider is present in a local machine of the service user, the model, which may be an intellectual property right, may be disclosed. Therefore, the service user may send their data to a server of the service provider; the service provider may perform an operation for the machine learning model using the received data as an input, and may then return a result therefrom to the service user; and the data of the service user may be encrypted and/or obfuscated to prevent disclosing the same. In these cases, security technologies supporting an operation for the encrypted or obfuscated data, such as HE, MPC, differential privacy, and/or the like may be used. Among these security technologies, HE and MPC may be used as the most important security technologies in PI, because they may be effective in terms of accuracy in modelling and a cost of an entire protocol.

In general, a convolutional neural network (CNN) may be a neural network mainly used to process, e.g., visual data (such as image and/or a video data), time-series data, audio data, and/or the like, in a deep neural network (DNN). In the CNN, a convolution kernel may be characteristically used, and convolution may perform an operation for a dot product by sliding an input feature map with a fixed weight known as a filter. In the CNN, in addition to a convolution layer, a machine learning model may be constructed by stacking a normalization layer normalizing an input, an activation function adding non-linearity to the input, and/or the like. In at least one example embodiment, the CNN may be predominantly used in an image classification task classifying an image from an input image.

A CNN machine learning model may be formed of a combination of a linear layer such as convolution, fully connected, or the like, and a non-linear layer such as ReLU or the like. Since homomorphic encryption and a multi-party computation may be more difficult to perform a non-linear operation such as ReLU, compared to a linear operation, the non-linear operation may have most of an execution time period and a cost in PI.

Homomorphic encryption (HE) may be an encryption method using a computational problem known as learning-with-error (LWE), and may perform an operation for encrypted data, e.g., a ciphertext, without decrypting the same, by a user. Such homomorphic encryption may be classified into different homomorphic encryption systems according to an encryption manner, an operation supporting the same, and/or the like. A homomorphic encryption system mainly used in machine learning may be based on the Cheon-Kim-Kim-Song (CKKS) and/or the BFV (Brakerski-Fan-Vercauteren) schemes. The two homomorphic encryption systems may store multiple data in a single ciphertext, and may perform an operation for the stored data, in parallel, using a single instruction multiple data (SIMD) method. Therefore, it is advantageous for machine learning workloads with a large amount of data and high parallelism of operation. Since CKKS and BFV may support only addition and multiplication operations among arithmetic operations, a non-linear operation such as ReLU may be approximated with a polynomial, which may be a combination of addition and multiplication operations. Details of homomorphic encryption have been filed by Samsung Electronics, US 2021-0328766 (Jong Seon No), US 2022-0094521 (Youngsik MOON), US 2022-0014351 (Ju-Young Jung), US 2021-0409189 (Dong-hoon Yoo), US 2021-0376996 (Youngsik MOON), US 2021-0376997 (Jin Soo Lim), US 2021-0351912 (Jong Seon No), US 2021-0351913 (Jong Seon No), US 2021-0344479 (Wijik LEE), and US 2021-0336765 (Jong Seon No), which are incorporated by reference herein.

A homomorphic encryption scheme may be divided into partially homomorphic encryption (PHE), somewhat homomorphic encryption (SHE), fully homomorphic encryption (FHE), and/or the like. The partially homomorphic encryption may allow only one type of mathematical operation (e.g., multiplication) on a given set of data. The somewhat homomorphic encryption may allow additions and multiplications on a given set of data a limited number of times. The fully homomorphic encryption may allow various types of operations on a set of data without limiting the number of times.

Various encryption schemes such as BGV (Brakerski-Gentry-Vaikuntanathan), BFV (Brakerski-Fan-Vercauteren), and/or CKKS (Cheon-Kim-Kim-Song) may be employed in the fully homomorphic encryption technology. These homomorphic encryption technologies may map a message to an nth-order polynomial pair (wherein n represents zero, one, or an integer greater than 1) in a process of encrypting the message according to definition of ring-learning-with-error (R-LWE), which may be a basic problem, may add a noise value known as an error polynomial, and may generate a ciphertext by an encryption operation processing process such as a process of including an encryption key polynomial in a message polynomial, and/or the like.

FIG. 3 is a view illustrating a homomorphic encryption system 10 according to at least one example embodiment. Referring to FIG. 3, a homomorphic encryption system 10 may include a homomorphic encryption device 11 and a homomorphic encryption operation device 12.

The homomorphic encryption device 11 may be implemented to convert plaintext into ciphertext and/or ciphertext into plaintext using a homomorphic encryption algorithm. In at least one example embodiment, the homomorphic encryption device 11 may be a user device. For example, the user device may be various electronic devices. In these cases, the electronic device may include a storage device, a portable communication device (e.g., a smartphone), a computer device, a portable multimedia device, a portable medical device, a camera, a wearable device, a home appliance device, and/or the like. In particular, the electronic device may be applied to an intelligent service (e.g., a smart home, a smart city, a smart car, health care service, and/or the like) based on a wireless communication technology and/or an internet-of-things (IoT) related technology.

The homomorphic encryption operation device 12 may include a homomorphic encryption operation accelerator 12-1 that performs an operation for ciphertexts transmitted from the homomorphic encryption device 11. In at least one example embodiment, the homomorphic encryption operation device 12 may be a server. For example, the server may provide a cloud service, and/or may provide an ultra-low latency service using distributed computing and/or mobile edge computing. In at least one embodiment, the server may be an intelligent server using machine learning/neural networks. The homomorphic encryption operation device 12 may include an approximate operation circuit. In these cases, the approximation operation circuit may be implemented to provide an approximation operation, to perform a search operation in homomorphic encryption. The homomorphic encryption operation accelerator 12-1 may be implemented to efficiently parallelize a numeric theoretic transform (NTT) operation and a base conversion (BaseConv) operation, which often occupies most of the time in the homomorphic encryption operation. In this case, the NTT operation includes transforming data to simplify complexity of polynomial multiplication of homomorphic ciphertexts. In these cases, the BaseConv operation includes converting a base set on an NTT domain into a base set on a residue number system (RNS). Therefore, an overall execution time period of the homomorphic encryption operation may be reduced. In addition, the homomorphic encryption operation accelerator 12-1 may be implemented to perform an operation through a hierarchical register file (RF) structure, when performing the BaseConv operation.

A multi-party computation (MPC) may be a security protocol in which two or more users input their own secret values and calculate function values together. The multi-party computation may be used to perform an operation for a result of a target function value, without knowing each other's input, which may be a secret of each user. For example, the MPC may have two security properties, and parties of the MPC may not infer information from an input, which may be a secret value held by the parties, from messages transmitted during protocol execution. For example, information that may be inferred about each other's secret values may be only a result of a function value (an output of the function). Also, MPC may not manipulate a protocol to output an incorrect result by malicious parties trying to attack the protocol among the protocol execution parties. For example, a protocol of the MPC may always calculate a correct result or may detect an error when malicious parties attack and may stop. Several protocols, such as a Shamir secret sharing, a Yao's garbled circuit, a Beaver triple, and/or the like may be present in the MPC.

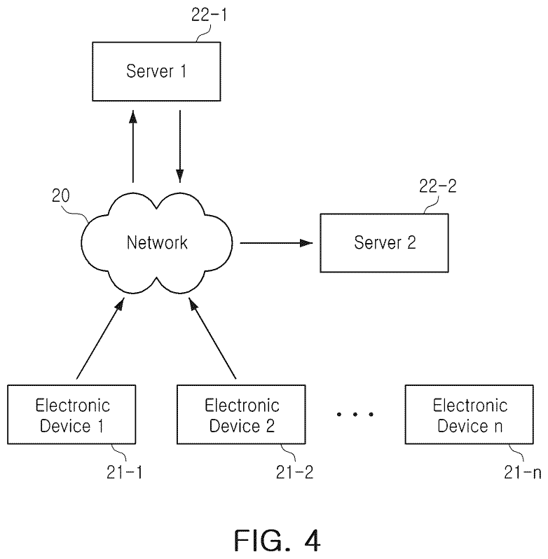

FIG. 4 is a view illustrating a structure of a network system for performing a multi-party computation according to at least one example embodiment. Referring to FIG. 4, a network system may include a plurality of electronic devices 21-1, 21-2, . . . , 21-n, a first server device 22-1, and a second server device 22-2, and each of the components may be connected to each other through a network 20.

The network 20 may be implemented as various types of wired and wireless communication networks, broadcast communication networks, optical communication networks, cloud networks, and/or the like. For example, each device may be connected via a wired local area network (LAN), a wireless local area network (WLAN) (such as a wireless fidelity (Wi-Fi)), a wireless personal area network (WPAN) (such as Bluetooth), a wireless universal serial bus (USB), Zigbee, near field communication (NFC), radio-frequency identification (RFID), power line communication (PLC), a communication interface capable of connecting to a mobile cellular network, (such as 3rd generation (3G), 4th generation (4G), 5th generation (5G), long term evolution (LTE), etc.) and/or the like, without a separate medium. Although illustrated in FIG. 4 that an electronic device is provided as a plurality of electronic devices 21-1 to 21-n, the plurality of electronic devices may be not necessarily used, and a single electronic device may be used. For example, the electronic devices 21-1 to 21-n may be implemented as various types of devices, such as a smartphone, a tablet PC, a game player, a PC, a laptop PC, a home server, a kiosk, and/or the like, and/or may also be implemented as a home appliance.

A user may input various information through the electronic devices 21-1 to 21-n used by the user. The input information may be stored in the electronic devices 21-1 to 21-n itself, or may be transmitted to and stored in an external device for reasons of storage capacity and security. In FIG. 4, a first server device 22-1 may serve to store such information, and a second server device 22-2 may serve to store some (or all) of the information stored in the first server device 22-1.

Each of the electronic devices 21-1 to 21-n may perform an operation, based on information provided by the first server device 22-1, and may provide an operation result to the first server device 22-1. For example, each of the electronic devices 21-1 to 21-n may be a party (or a user) in a distributed computing system in a multi-party computing system. The first server device 22-1 may store the received homomorphic ciphertext as a ciphertext, without decrypting the same. The second server device 22-2 may request a specific processed result for the homomorphic ciphertext from the first server device 22-1. The first server device 22-1 may perform an operation according to the request of the second server device 22-2, and may then transmit a result therefrom to the second server device 22-2. In these cases, the first server device 22-1 may perform a requested operation using the plurality of electronic devices 21-1 to 21-n.

For example, the first server device 22-1 may generate a triple (necessary for an operation for a ciphertext) together with the other electronic devices 21-1 to 21-n, and may share the generated triple. In these cases, the first server device 22-1 may generate a triple of, e.g., 2 that may be calculated by a power law, together with other devices. Also, the first server device 22-1 may use a similar polynomial interpolation method, when generating the triple. When the first server device 22-1 receives an operation result performed by each of the electronic devices, the first server device 22-1 may verify the received operation result by zero-knowledge proof, and may use an operation result from which the zero-knowledge proof is completed, to generate a result value corresponding to the requested operation. In addition, the first server device 22-1 may provide the operation result to the second server device 22-2 in which the operation has been requested.

A network system according to at least one example embodiment may generate a ciphertext for a plurality of messages using a similar interpolation method, and may perform a multi-party calculation using the generated ciphertext, to perform an operation at low communication costs. In the illustration and description of FIG. 4, the first server device 22-1 has been illustrated and described as generating a triple, but in implementation, the second server device 22-2 (and/or one of the plurality of electronic devices 21-1 to 21-n), described above, may generate the triple.

In general, a homomorphic encryption system such as a CKKS and a BFV may support only a polynomial operation that may be generated by a combination of addition and multiplication, to replace ReLU with polynomial approximation, based on numerical analysis. Polynomial approximation of the ReLU in a deep machine learning model requires a very high-order polynomial, (for example, 150 orders of magnitude or more in a model such as ResNet20), which may be a bottleneck in the PI. When a low-order polynomial is used in training a machine learning model, a problem of an exploding and vanishing gradient in which a gradient size is very large or small may occur in a gradient descent algorithm, making training difficult.

Next, there may be several protocols in multi-party computation (MPC). A protocol frequently used in the PI may be, e.g., a garbled circuit (GC) and a Beaver triple (BT). First, the GC may be an MPC protocol transforming a function to be calculated into a binary circuit and operating the same. The GC may consist of two parties, and roles thereof may be divided into a garbler encrypting information necessary for a GC operation, and an evaluator receiving encrypted values from the garbler and performing an operation therefor. The garbler may encrypt a truth table of XOR, AND, OR, and/or NOR, which are gates of a modified binary circuit. This process may be known as garbling. An encrypted binary circuit created as a result of garbling may be known as a garbled circuit. The Evaluator may receive the garbled circuit from the garbler, and may calculate a result of the function, without knowing the encrypted binary circuit and information about the garbler's input value. Since an ReLU function may be transformed into the binary circuit, an operation may be performed with the GC. An amount of calculation and an amount of network communication, required to perform an operation for ReLU using the GC, may be large.

The Beaver triple (BT) may be also an MPC protocol consisting of two parties, and performing a multiplication operation. The BT may support only the multiplication operation, but the multiplication operation may be performed with minimal overhead. When an ReLU operation is replaced with a polynomial operation of 2^{nd}-order by the BT, an execution time period and an amount of network communication may be greatly reduced by 2843 times and 256 times, respectively, compared to when using the GC.

In a PI framework using the MPC, an operation for the ReLU may be performed using the GC to perform an operation for an activation function of the machine learning model, and/or the ReLU may be replaced with a polynomial function and calculated as BT. A method of replacing the ReLU with the polynomial function may greatly increase performance of PI, but there may be no effective way to replace the ReLU with the polynomial function. As a result, when using the MPC in conventional PI, an operation for the ReLU with the GC may cause a big bottleneck phenomenon.

The private inference (PI) according to at least one example embodiment may replace an activation function with a function using Hermitic expansion. The Hermitic expansion may be performing a Fourier transform using a Hermite polynomial as an eigenfunction. Mathematically, the Hermite polynomial may be an orthogonal polynomial sequence. Standards of Hermite polynomial generally used in statistics and physics may be different. In statistics, a Hermite polynomial may be expressed as Equation 1.

$${H}_{n} ( x ) = {( - 1 )}^{n} {e}^{\frac{{x}^{2}}{2}} \frac{{d}^{n}}{{dx}^{n}} {e}^{\frac{- {x}^{2}}{2}} \qquad [ Equation 1 ]$$

The Hermite polynomial may be expressed as differentiation of an exponential function, but a polynomial may be obtained by performing a differential operation. For example, expressions of Hermite polynomials up to 5th-order may be the same as Equation 2.

H₀(X)=1,

H₁(X)=x,

H₂(X)=x²−1,

H₃(X)=x³−3x,

H₄(X)=x⁴−6x²+3,

H₅(X)=x⁵+10x³−15x [Equation 2]

As in the polynomial expressions above, an order of an nth-order Hermite polynomial may be n, and may have 1 as a coefficient of the highest order.

In general, a Hermite polynomial may be characterized by orthogonality and completeness. The Hermite polynomial has orthogonality with respect to a Gaussian weight function, which may be expressed as Equation 3.

$$w ( x ) = {e}^{\frac{- {x}^{2}}{2}} \qquad [ Equation 3 ]$$

The orthogonality of the Hermite polynomial may be expressed as Equation 4 as follows.

$${\int }_{- INF}^{INF} {H}_{m} ( x ) {H}_{n} ( x ) w ( x ) dx = \{ \begin{matrix}0 & if m \neq n \\ \sqrt{2 π} n ! & if m = n\end{matrix} \qquad [ Equation 4 ]$$

For example, the Hermite polynomial may be an orthogonal polynomial sequence (e.g., orthogonal to a standard normal probability density function).

Also, the Hermite polynomial may form an orthogonal basis with respect to functions of Hilbert space. Hilbert space may be an inner product space in which limits of all Cauchy sequences exist. Functions of the Hilbert space may be finite in magnitude as in Equation 5.

∫_{-∞}^{∞}|f(x)|²w(x)dx<∞ [Equation 5]

An inner product in the Hilbert space may be expressed as Equation 6 below.

<f,g>=∫_{-INF}^{INF}f(x)g̅(̅x̅)̅w(x)dx [Equation 6]

In the Hilbert space L²(R,w(x)), the Hermite polynomial may form an orthogonal basis. In these cases, R denotes a real number interval (−∞, ∞). Therefore, a normalized Hermite polynomial may form an orthonormal basis in the Hilbert space. For a function ƒ∈L²(R,w(x)) in the Hilbert space, expressing the function using the normalized Hermite polynomial as a basis may be known as Hermitic expansion, and may be expressed as in Equation 7.

$$f ( x ) = {\sum }_{i = 0}^{INF} {\hat{f}}_{i} {h}_{i} ( x ) , {\hat{f}}_{i} = 〈 f , {h}_{i} 〉 \qquad [ Equation 7 ]$$

An activation function proposed in the present inventive concepts may first express the ReLU as the Hermitic expansion, as illustrated in Equation 8.

$$ReLU ( x ) = {\sum }_{i = 0}^{INF} {\hat{f}}_{i} {h}_{i} ( x ) , {\hat{f}}_{i} = 〈 ReLU , {h}_{i} 〉 \qquad [ Equation 8 ]$$

A coefficient \hat{f}ᵢ of the Hermitic expansion of the ReLU may be as illustrated in

Equation 9.

$${\hat{f}}_{n} = \{ \begin{matrix}\frac{1}{\sqrt{2 π}} & n = 0 , \\ \frac{1}{2} & n = 1 , \\ 0 & n ≧ 2 and odd \\ \frac{( ( n - 3 ) !! )}{\sqrt{2 π n !}} & n ≧ 2 and even\end{matrix} \qquad [ Equation 9 ]$$

For a general activation function ƒ(x), the Hermitic expansion may be applied as in

Equation 10.

$$f ( x ) = {\sum }_{i = 0}^{INF} \hat{{f}_{i}} {h}_{i} ( x ) \qquad [ Equation 10 ]$$

For a general activation function ƒ(x), the Hermitic coefficient may be generated as follows.

\hat{f}ᵢ=<f,hᵢ>=∫_{-INF}^{INF}f(x)h̅ᵢ̅(̅x̅)̅w(x)dx [Equation 11]

For several activation functions, the coefficient \hat{f}ᵢ of the Hermitic expansion may be given by Equation 12.

$$step function \\ {\hat{f}}_{n} = \{ \begin{matrix}\frac{( ( n - 2 ) !! )}{\sqrt{4 π n !}} & even , \\ \frac{1}{2} & n = 1 , \\ 0 & n ≧ 3 and odd\end{matrix} \\ sigmoid function \\ {f}_{0} = \frac{\sqrt{2}}{4} \\ {f}_{1} = 0.146103 \\ {f}_{2} = 0 \\ {f}_{3} = … \\ swish function \\ {f}_{0} = 0.206621 \\ {f}_{1} = 0.5 \\ {f}_{2} = 0.248045 \\ {f}_{3} = … \qquad [ Equation 12 ]$$

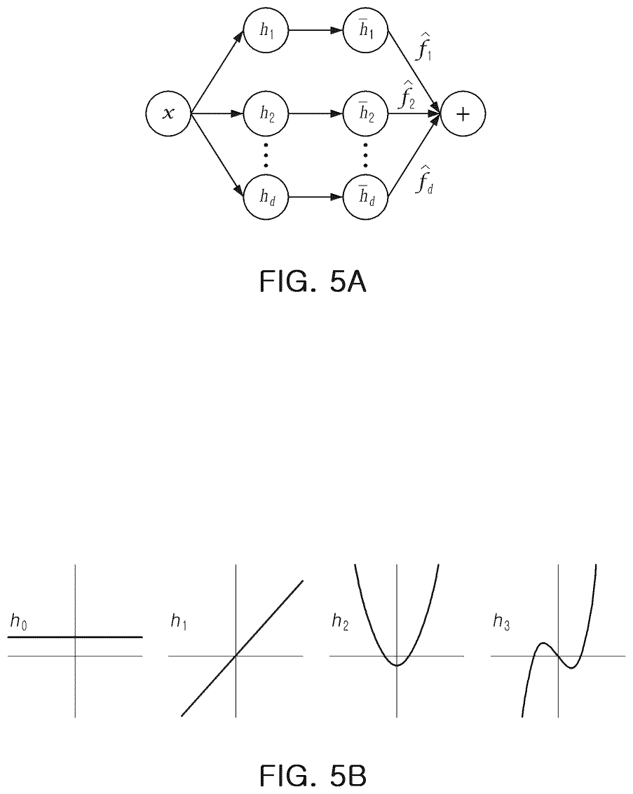

In these cases, to reduce an amount of computation in the Hermitic expansion, training is possible even when only Hermite polynomials to a low-order (e.g., a second-order) Hermite polynomial are used. Hermite polynomials up to a 3^{rd}-order Hermite polynomial may be expressed as a graph. FIG. 5A is a view illustrating an HerPN activation function combining Hermitic expansion and basis-wise batch normalization, and FIG. 5B is a view illustrating Hermite polynomial graphs up to a 3^{rd}-order Hermite polynomial.

For standard deviation (σ) and mean (μ) with respect to batch of inputs of scale (y) and shift (β), which are parameters of batch normalization, HerPN may be calculated as follows.

$$\begin{matrix}f ( x ) = γ {\sum }_{i = 0}^{d} \hat{{f}_{i}} \frac{{h}_{i} ( x ) - μ}{\sqrt{{σ}^{2} + ϵ}} + β & \hat{{f}_{i}} = 〈 f , {h}_{i} 〉\end{matrix} \qquad [ Equation 13 ]$$

In the present inventive concepts, after performing operations for Hermite polynomials from Hermitic expansion of ReLU, and before summing them, a batch normalization operation may be performed. In this manner, performing the batch normalization operation for each of the Hermite polynomials will be referred to as basis-wise batch normalization. For example, after performing an operation for each Hermite polynomial on an input value, a batch normalization operation may be performed on each Hermite polynomial. Then, the normalized Hermite polynomials may be multiplied by a coefficient of the Hermitic expansion, and a sum thereof may be output. An activation function of the present inventive concepts in which the Hermitic expansion of ReLU and basis-wise batch normalization are combined may be expressed as a left side of FIG. 1, and will be referred to as an HerPN (Hermite polynomial) activation function.

The present inventive concepts propose a low-order polynomial activation function that may replace an activation function of a machine learning model using Hermitic expansion. In homomorphic encryption, to approximate the activation function of the machine learning model, a high-order polynomial (e.g., 150^{th}-order polynomials) had to be used in the past, but the present inventive concepts may use a low-order polynomial like a second-order polynomial, thereby reducing operation costs. In addition, a GC protocol had to be used to calculate the activation function of the machine learning model in multi-party computation, but a BT protocol having a relatively inexpensive cost may be used to have a relatively inexpensive operation cost and a relatively small amount of network communication. Compared to calculating ReLU by the GC protocol, calculating a second-order polynomial function by the BT protocol may reduce an execution time period by 2843 times and an amount of network communication by 256 times.

In addition, unlike an existing method that may replace only a portion of an entire activation function of the machine learning model, according to the present inventive concepts, the entire activation function of the machine learning model may be replaced with a second-order polynomial. In these cases, the second-order polynomial may be the simplest polynomial that may be used as the activation function in the machine learning model, in view that the second-order polynomial is a polynomial of a minimum order with non-linearity. When the machine learning model is used using the activation function presented in the present inventive concepts, it may be trained with classification accuracy equivalent to the ReLU activation function in a commonly used deep CNN network such as VGG16, ResNet32/18, or Preactivation ResNet32/18.

The private inference according to at least one example embodiment may use the HerPN (Hermite polynomial) block in a general deep learning CNN model to replace an existing ReLU activation function and/or a batch normalization layer.

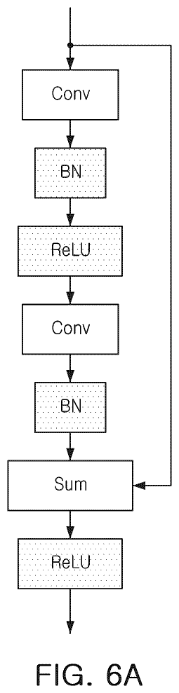

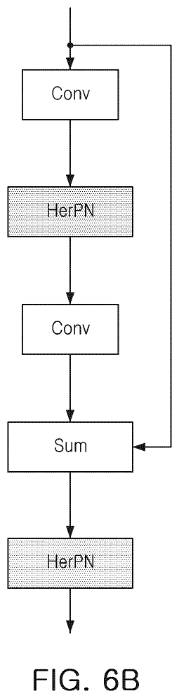

FIG. 6A is a view illustrating a network using ReLU in a residual neural network (ResNet), and FIG. 6B is a view illustrating a network using HerPN in ResNet. When there is a residual connection between a batch normalization layer (BN) and an ReLU activation function as in the ResNet of FIG. 6A, a method of performing an operation for an HerPN block after performing an operation for the residual connection may be replaced, as illustrated in FIG. 6B.

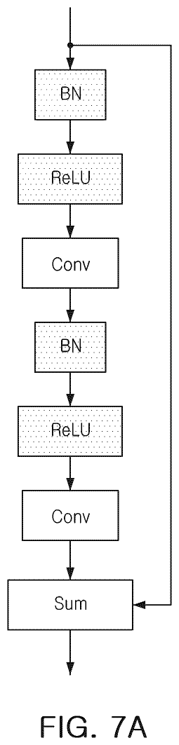

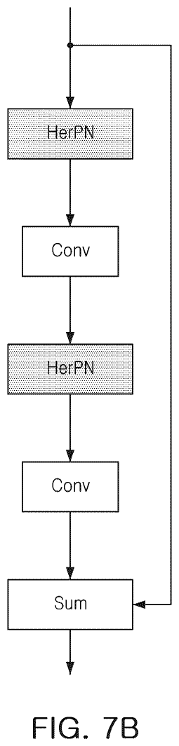

FIG. 7A is a view illustrating a network using ReLU in Preactivation ResNet (PA-ResNet), and FIG. 7B is a view illustrating a network using HerPN in PA-ResNet. Referring to FIG. 7B, when a batch normalization layer and an ReLU activation function are adjacent to each other, as illustrated in FIG. 7A, the batch normalization layer and the ReLU activation function may be substituted with an HerPN block.

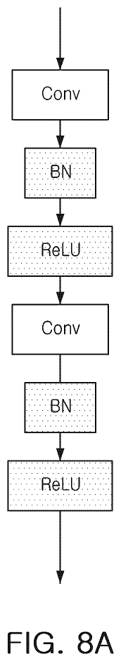

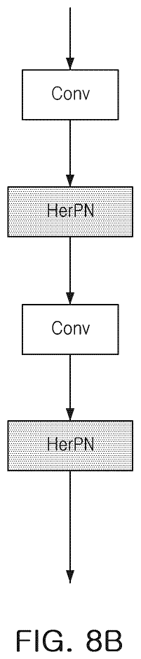

FIG. 8A is a view illustrating a network using ReLU in a visual geometry group (VGG), and FIG. 8B is a view illustrating a network using HerPN in VGG. Referring to FIG. 8B, when a batch normalization layer and an ReLU activation function are adjacent to each other, as illustrated in FIG. 8A, the batch normalization layer and the ReLU activation function may be substituted with an HerPN block.

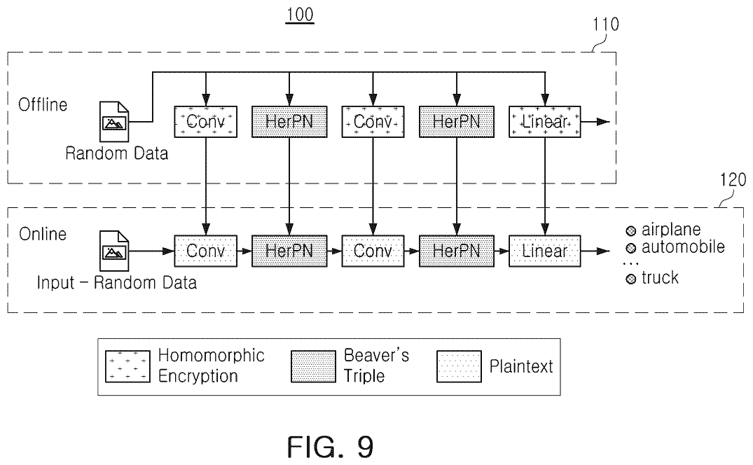

FIG. 9 is a view illustrating a privacy deep learning system 100 according to at least one example embodiment. Referring to FIG. 9, a privacy deep learning system 100 may include an offline deep learning system 110 and an online deep learning system 120. In this case, the offline deep learning system 110 and the online deep learning system 120 may be implemented by a client device 11 (see FIG. 3) and a cloud server 12 (see FIG. 3), respectively.

A private inference (PI) protocol may be divided into an offline phase and an online phase. An operation is possible without dividing the PI protocol into offline and online phases. Before the client device 11 transmits actual plaintext data x to the cloud server 12, an operation may be precomputed by, e.g., randomly generating the data. The cloud server 12 may process the private inference (PI) further faster, when the client device 11 has sent the data x. In this manner, before the client device 11 sends the actual data x, a phase of precomputing with randomly generated data may be known as the offline phase. The phase of sending and calculating actual data may be known as the online phase.

As illustrated in FIG. 9, in the offline phase, the client device 11 may encrypt randomly generated data in a linear layer (e.g., a convolution operation, a fully connected (FC) operation), and may transmit the encrypted data to the cloud server 12.

The cloud server 12 may perform a convolution operation and an FC operation using a homomorphic encryption scheme, and may transmit an operation result f(r) to the client device 11.

Also, in the online phase, when the client device has the actual data x, a difference value (x-r) between the actual data and the random data may be transmitted to the cloud server. The cloud server may perform an operation for the data and the random data through homomorphic encryption, and transmit the operated value (f(x-r)) to the client device. Since the client device knows f(r), the client device may also know f(x) through a relation f(x)=f(x-r)+f(r). In this manner, the homomorphic encryption operations in PI protocol may be used only in an offline state.

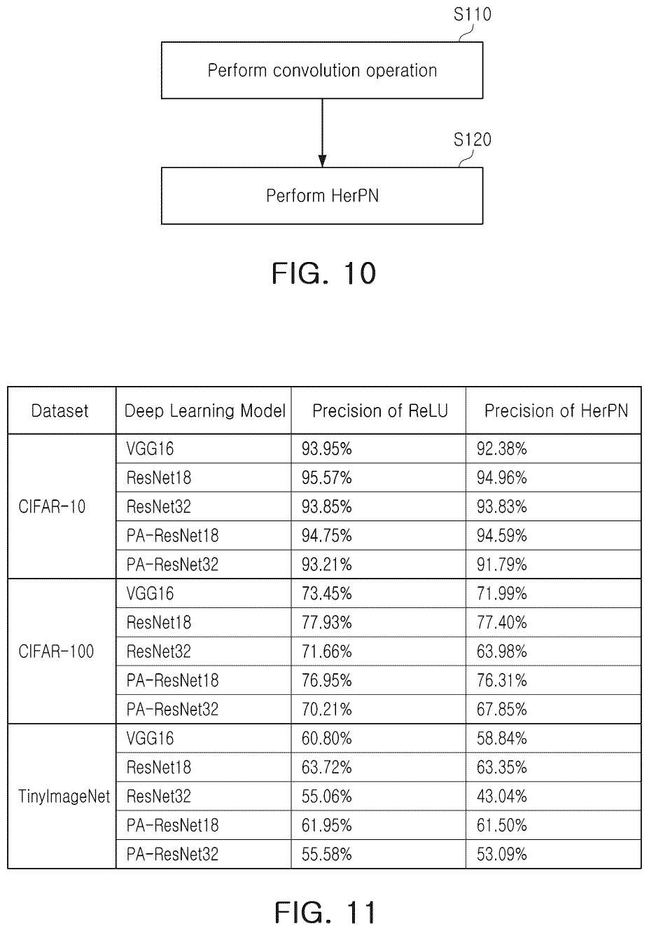

FIG. 10 is a flowchart illustrating an operating method of a deep learning system according to at least one example embodiment. Referring to FIGS. 1 to 10, a deep learning system may operate as follows. A convolution action with regard to input values may be performed (S110). In these cases, the input values may be values encrypted by a homomorphic encryption scheme. In at least one example embodiment, the homomorphic encryption scheme may be at least one of a BGV (Brakerski-Gentry-Vaikuntanathan), BFV (Brakerski-Fan-Vercauteren), and/or CKKS (Cheon-Kim-Kim-Song). For the convolution action, a prediction action may be performed using HerPN as an activation function (S120). The HerPN may use Hermit expansion. For example, the Hermitic expansion may be Hermitic expansion of an ReLU activation function. In at least one example embodiment, the Hermitic expansion may be used for training up to a second-order Hermite polynomial. In at least one example embodiment, after performing an operation for the Hermite polynomial, a batch normalization operation for the Hermite polynomial may be performed. In at least one example embodiment, a result value of multiplying the normalized Hermite polynomial by a coefficient of the Hermitic expansion and adding the multiplied values thereto may be output. In at least one example embodiment, the activation function may be converted into a non-linear activation function by the Hermitic expansion. In at least one example embodiment, privacy deep learning may use one of VGG, ResNet, Preactivation ResNet, and/or the like. In at least one example embodiment, the activation function may be calculated by an addition operation and a multiplication operation.

FIG. 11 is a view illustrating classification accuracy of ReLU and HerPN in a deep learning CNN model according to at least one example embodiment. Referring to FIG. 11, results of training ResNet18/32, Preactivation ResNet18/32, and VGG16 with HerPN blocks in CIFAR10, CIFAR100, and TinylmageNet, which may be image classification tasks, are illustrated. As can be seen, the precision of the privacy inference from the deep learning model using HerPN, while protecting privacy data of a service user, is shown to be comparable to the precision of the equivalent unprotected model using ReLU.

The user device according to at least one example embodiment may be a smart storage device.

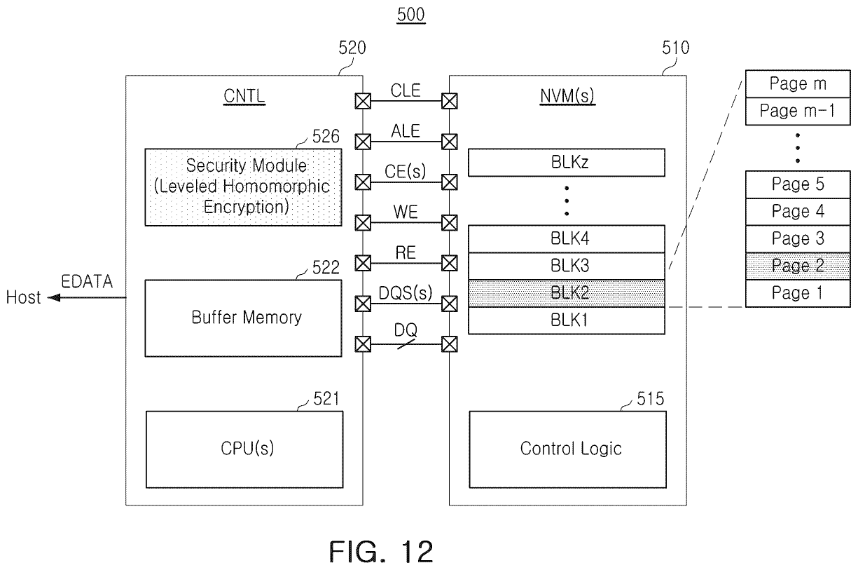

FIG. 12 is a view illustrating a storage device 500 according to at least one example embodiment. Referring to FIG. 12, a storage device 500 may include at least one non-volatile memory device NVM(s) 510 and a controller CNTL 520.

At least one non-volatile memory device 510 may be implemented to store data. The non-volatile memory device 510 may include, e.g., a NAND flash memory, a vertical NAND flash memory, a NOR flash memory, a resistive random-access memory (RRAM), a phase-change memory (PRAM), a magnetoresistive random access memory (MRAM), a ferroelectric random-access memory (FRAM), a spin transfer torque random access memory (STT-RAM), and/or the like. Also, in at least one embodiment, the non-volatile memory device 510 may be implemented in a three-dimensional array structure. In at least one example embodiment, the non-volatile memory device 510 may include a flash memory device in which the charge storage layer is configured as a conductive floating gate, and/or to a charge trap flash (CTF) in which a charge storage layer is configured as an insulating film. Hereinafter, the non-volatile memory device 510 will be referred to as a vertical NAND flash memory device for ease of description.

the non-volatile memory device 510 may be implemented to include a plurality of memory blocks BLK1 to BLKz (z is an integer equal to or greater than 2) and a control logic 150. Each of the plurality of memory blocks BLK1 to BLKz may include a plurality of pages Page 1 to Page m (m is an integer equal to or greater than 2). Each of the plurality of pages Page 1 to Page m may include a plurality of memory cells. Each of the plurality of memory cells may store at least one bit.

The control logic 515 may receive a command and an address from the controller 520 (CNTL), and may perform an operation (a program operation, a read operation, erase operation, or the like,) corresponding to the received command on memory cells corresponding to the address.

The controller 520 (CNTL) may be connected to at least one non-volatile memory device 510 through a plurality of control pins for transmitting control signals (e.g., CLE, ALE, CE(s), WE, RE, and/or the like). Also, the controller 520 may be implemented to control the non-volatile memory device 510 using control signals CLE, ALE, CE(s), WE, RE, and/or the like). For example, the non-volatile memory device 510 may latch a command or an address on an edge of a write enable (WE)/read enable (RE) signal according to a command latch enable (CLE) signal and an address latch enable (ALE) signal, such that program operation/read operation/erase operation may be performed.

For example, during a read operation, the chip enable signal CE may be activated, CLE may be activated during a command transmission period, ALE may be activated during an address transmission period, and RE may be toggled during a period in which data is transmitted through a data signal line DQ. The data strobe signal DQS may be toggled with a frequency corresponding to a data input/output speed. Read data may be transmitted in sequence in synchronization with the data strobe signal DQS.

Also, the controller 520 may include at least one processor 521 (such as a central processing units (CPUs)), a buffer memory 522, a security module 526, and/or the like.

The processor 521 may be implemented to control overall operation of the storage device 500. The processor 521 may perform various management operations such as cache/buffer management, firmware management, garbage collection management, wear leveling management, data deduplication management, read refresh/reclaim management, bad block management, multi-stream management, mapping of host data and non-volatile memory, quality of service (QoS) management, system resource allocation management, non-volatile memory queue management, read level management, erase/program management, hot/cold data management, power loss protection management, dynamic thermal management, initialization management, redundant array of inexpensive disk (RAID) management, and/or the like.

The buffer memory 522 may be implemented as a volatile memory (e.g., a static random-access memory (SRAM), a dynamic RAM (DRAM), a synchronous RAM (SDRAM), and/or the like), and/or a non-volatile memory (a flash memory, a phase-change RAM (PRAM), a magneto-resistive RAM (MRAM), a resistive RAM (ReRAM), a ferroelectric RAM (FRAM), and/or the like).

The security module 526 may be implemented to perform a security function of the storage device 500. For example, the security module 526 may perform a self encryption disk (SED) function or a trusted computing group (TCG) security function. The SED function may store encrypted data in the non-volatile memory device 510 using an encryption algorithm or may decrypt data encrypted from the non-volatile memory device 510. The encryption/decryption operation may be performed using an internally generated encryption key. In at least one example embodiment, the encryption algorithm may be an advanced encryption standard (AES) encryption algorithm. However, the encryption algorithm is not limited thereto. The TCG security function may provide a mechanism enabling access control to user data on the storage device 500. For example, the TCG security function may perform an authentication procedure between an external device and the storage device 500. In an example embodiment, the SED function or the TCG security function may be optionally selected.

In addition, the security module 526 may be implemented to perform the homomorphic encryption operation described in FIG. 3. For example, the security module 526 may generate a ciphertext (EDATA) based on a leveled homomorphic encryption algorithm. The security module 526 may receive the operation result received from the host device and may decrypt the result based on the leveled homomorphic encryption algorithm.

In addition, the security module 526 may perform multi-party computation (MPC) with an external storage device or an external server, as described with reference to FIG. 4.

In addition, the security module 526 may be implemented to perform all or portion of a deep learning operation using an activation function using the Hermitic expansion, as described with reference to FIGS. 1 to 11.

The present inventive concepts may be applicable to an electronic device having a storage device.

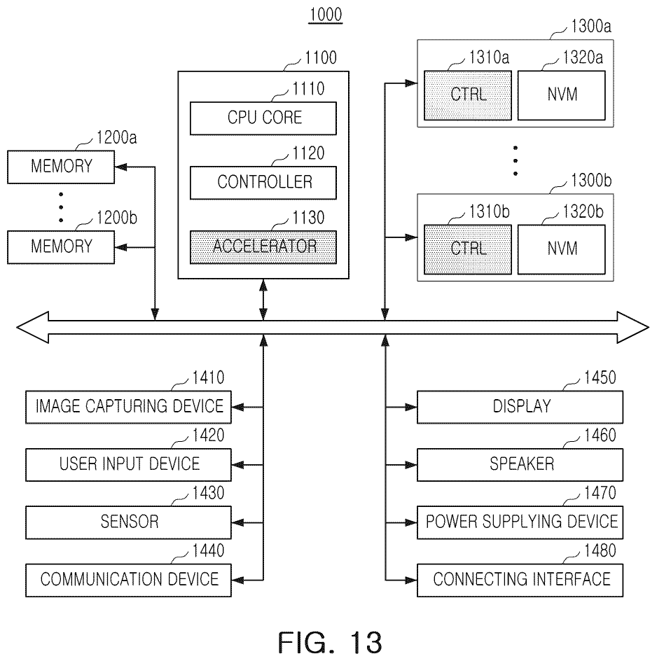

FIG. 13 is a view illustrating an electronic device 1000 to which a storage device according to at least one example embodiment is applied. An electronic device 1000 illustrated in FIG. 13 may be implemented as a mobile system such as a mobile phone, a smart phone, a tablet personal computer (PC), a wearable device, a health care device, or an Internet of Things (IoT) device. However, the electronic device 1000 in FIG. 13 is not necessarily limited to a mobile system, and may be implemented as a personal computer, a laptop computer, a server, a media player, an automotive device such as a navigation device, and/or the like.

Referring to FIG. 13, the electronic device 1000 may include a main processor 1100, memories 1200a and 1200b, and storage devices 1300a and 1300b. Also, the electronic device 1000 may further include one or more of an image capturing device 1410, a user input device 1420, a sensor 1430, a communication device 1440, a display 1450, a speaker 1460, a power supplying device 1470, a connecting interface 1480, and/or the like.

The main processor 1100 may control overall operation of the electronic device 1000, more specifically, operations of other components included in the electronic device 1000. The main processor 1100 may be implemented as a general processor, a dedicated processor, an application processor, and/or the like.

In at least one embodiment, the main processor 1100 may include one or more CPU cores 1110. Also, the main processor 1100 may further include a controller 1120 for controlling the memories 1200a and 1200b and/or the storage devices 1300a and 1300b. In at least one example embodiment, the main processor 1100 may further include an accelerator 1130 which may be a dedicated circuit for high-speed data operation such as artificial intelligence (AI) data operation. The accelerator 1130 may include, e.g., a graphics processing unit (GPU), a neural processing unit (NPU), a data processing unit (DPU), and/or the like. The accelerator 1130 may be implemented as an accelerator that performs the homomorphic encryption operation described with reference to FIGS. 1 to 13, and/or performs a multi-party computation. The accelerator 1130 may be implemented as a chip physically independent from the other components of the main processor 1100.

The memories 1200a and 1200b may be used as main memory devices of the electronic device 1000. The memories 1200a and 1200b may include volatile memories such as SRAM or DRAM, and/or may include non-volatile memories such as a flash memory, PRAM or RRAM. The memories 1200a and 1200b may be implemented in the same package as the main processor 1100.

The storage devices 1300a and 1300b may be implemented as non-volatile storage devices storing data regardless of whether power is supplied or not. The storage devices 1300a and 1300b may have a relatively large storage capacity as compared to that of the memories 1200a and 1200b. The storage devices 1300a and 1300b may include memory controllers 1310a and 1310b and non-volatile memory (NVM) 1320a and 1320b for storing data under control of the memory controllers 1310a and 1310b. The non-volatile memories 1320a and 1320b may include a flash memory having a two-dimensional (2D) structure or a three-dimensional (3D) vertical NAND (V-NAND) structure, and/or may include other types of non-volatile memory such as PRAM or RRAM. Also, the storage devices 1300a and 1300b may be implemented to perform an encryption/decryption operation using a homomorphic encryption algorithm.

The storage devices 1300a and 1300b may be included in the electronic device 1000 in a state of being physically separated from the main processor 1100. Also, the storage devices 1300a and 1300b may be implemented in the same package as the main processor 1100. Also, the storage devices 1300a and 1300b may have the same shape as a solid state device (SSD), a memory card, and/or the like, such that the storage devices may be detachable to the other components of the electronic device 1000 through an interface such as the connecting interface 1480. The storage devices 1300a and 1300b may be applied with standard protocols such as universal flash storage (UFS), embedded multi-media card (eMMC), and/or non-volatile memory express (NVMe), but the example embodiments thereof are not limited thereto.

The image capturing device 1410 may be configured to obtain a still image or a video. The image capturing device 1410 may be implemented, for example, as a camera, a camcorder, a webcam, and/or the like.

The user input device 1420 may receive various types of data input from a user of the electronic device 1000, and may be implemented, for example, as a touch pad, a keypad, a keyboard, a mouse, a microphone, and/or the like.

The sensor 1430 may detect various types of physical quantities which may be obtained from an external entity of the electronic device 1000, and may convert the sensed physical quantities into electrical signals. The sensor 1430 may be implemented as a temperature sensor, a pressure sensor, an audio detector, an illuminance sensor, a position sensor, an acceleration sensor, a biosensor, a gyroscope sensor, and/or the like. The communication device 1440 may transmit wired/wireless signals and/or receive wired/wireless signals from external devices of the electronic device 1000 according to various communication protocols. The communication device 1440 may include, for example, an antenna, a transceiver, a modem (MODEM), and/or the like. The display 1450 and the speaker 1460 may function as output devices configured to output visual information and auditory information, respectively, to the user of the electronic device 1000. The power supply device 1470 may appropriately convert power supplied from a battery embedded in the electronic device 1000 and/or an external power source and may supply power to each component of the electronic device 1000.

The connecting interface 1480 may provide connection between the electronic device 1000 and an external device connected to the electronic device 1000 to exchange data with the system 1000. The connecting interface 1480 may be implemented by various interface methods such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, universal serial bus (USB), secure digital (SD) card, multi-media card (MMC), eMMC, UFS, embedded universal flash storage (eUFS), compact flash (CF) card interface, and/or the like.

The present inventive concepts may be applied to a private inference service protecting privacy. For example, MLaaS may be provided in a cloud/edge while protecting users' sensitive data such as medical images/videos, financial status, genetic information, and/or the like.

In general, when an allowable area of a silicon chip is small, such as in an embedded system, various arithmetic logic units (ALUs) may not be mounted. In the present inventive concepts, an activation function of a machine learning model may be calculated using only addition and multiplication operators, which may be basic arithmetic operators. In addition, costs of addition and multiplication operations in a computing device may be the lowest. It is available when there is a shortage of arithmetic operators such as embedded systems or when a low-cost operation is desired to be used.

The private inference according to at least one example embodiment may be implemented in a computing device. The computing device may include at least one processor, a memory device, an input/output device, and a storage device, connected to a system bus.

The at least one processor may be implemented to control an overall action of the computing device. The processor may be implemented to execute at least one instruction. For example, the processor may be implemented to execute software (application programs, operating systems, device drivers) to be executed on the computing device. The processor may execute an operating system loaded into the memory device. The processor may execute various application programs to be driven based on the operating system. For example, the processor may run a deep learning algorithm that performs a private inference from the memory device. As noted above, in at least one example embodiment, the processor may be a central processing unit (CPU), a microprocessor, an application processor (AP), and/or any processing device similar thereto.

The memory device may be implemented to store at least one instruction. For example, the memory device may be loaded with an operating system or application programs. In at least one embodiment, when the computing device is booted, an OS image stored in the storage device may be loaded into the memory device, based on a boot sequence. All input/output actions of the computing device may be supported by the operating system. Similarly, application programs may be loaded into the memory device to be selected by the user or to provide basic services. For example, a privacy deep learning tool may be loaded from a storage device into a memory device. In addition, the memory device may be a volatile memory such as dynamic random access memory (DRAM), static random access memory (SRAM), and/or the like, and/or a non-volatile memory such as a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), and/or the like.

The input/output device may be implemented to control user input and output from a user interface device. For example, the input/output device may include input means such as a keyboard, a keypad, a mouse, a touch screen, and/or the like, to receive input information required for deep learning. In addition, the input/output device may include an output means such as a printer and a display to display the processing process and result of the privacy deep learning tool.

The storage device may be provided as a storage medium of a computing device. The storage device may store application programs, an OS image, and various data. The storage device may be provided in the form of a mass storage device such as a memory card (MMC, eMMC, SD, Micro SD, etc.), a hard disk drive (HDD), a solid-state drive (SSD), a universal flash storage (UFS), and/or the like.

In the above-described embodiments, components according to embodiments of the present inventive concepts may be referred to by using blocks. The blocks may be implemented with various hardware devices such as an integrated circuit (IC), an application specific IC (ASIC), a field programmable gate array (FPGA), a complex programmable logic device (CPLD), and/or the like, a firmware running on the hardware devices, a software such as an application, or a combined form of the hardware device and the software. In addition, the blocks may include circuits composed of semiconductor elements in the IC or circuits registered as intellectual property (IP).

A deep learning system for performing private inferences and an operating method thereof, according to at least one example embodiment, may perform rapidly an operation through an activation function using Hermitic expansion and significantly reduce an amount of the operation.

While example embodiments have been illustrated and described above, it will be apparent to those skilled in the art that modifications and variations could be made without departing from the scope of the present inventive concepts as defined by the appended claims.

What is claimed is:

1. An operating method of a deep learning system configured to perform a private inferences, comprising:
performing a convolution operation with respect to the encrypted input values; and
outputting result values from the convolution operation based on a determination using an activation function,
wherein the activation function includes a Hermitic expansion using a Hermite polynomial as an eigenfunction to perform a Fourier transform.

2. The method of claim 1, wherein the encrypted input values are values encrypted based on a homomorphic encryption scheme.

3. The method of claim 2, wherein the homomorphic encryption scheme is at least one of BGV (Brakerski-Gentry-Vaikuntanathan), BFV (Brakerski-Fan-Vercauteren), or CKKS (Cheon-Kim-Kim-Song).

4. The method of claim 1, wherein the Hermitic expansion is a Hermitic expansion of a rectified linear unit (ReLU) activation function.

5. The method of claim 1, wherein the Hermite polynomial is a second-order Hermite polynomial.

6. The method of claim 1, wherein the outputting the result values comprises:
performing a batch normalization operation for the Hermite polynomial.

7. The method of claim 6, wherein the outputting the result values further comprises:
multiplying the normalized Hermite polynomial by a coefficient of the Hermitic expansion;
summing the multiplied values; and
outputting the summed value as at least one of the result values.

8. The method of claim 1, wherein the using the activation function includes transforming a non-linear activation function through the Hermitic expansion.

9. The method of claim 1, wherein the deep learning system uses at least of one of a visual geometry group (VGG), residual neural network (ResNet), or Preactivation ResNet.

10. The method of claim 1, wherein the activation function used on a result of an addition operation and a multiplication operation.

11. A deep learning system including a neural network trained to perform private inferences, comprising:
a client device configured to pre-calculate randomly generated data; and
a cloud server configured to receive the pre-calculated data from the client device, to generate, using the neural network, operated values by performing a homomorphic encryption operation with respect to the received pre-calculated data, and to output the operated values based on determination using an activation function,
wherein the activation function includes a Hermitic expansion using a Hermite polynomial as an eigenfunction to perform a Fourier transform.

12. The deep learning system of claim 11, wherein the homomorphic encryption operation includes performing a convolution action based on a homomorphic encryption scheme, and the output the operated values includes transmitting a result of the convolution action to the client device.

13. The deep learning system of claim 12, wherein the client device is configured to output the transmitted result value using the activation function.

14. The deep learning system of claim 12, wherein the client device is configured to receive random data and the transmitted result value, and to perform a convolution action on plaintext included in at least one of the random data or the transmitted result value.

15. The deep learning system of claim 11, wherein the cloud server is configured to perform an operation based on a multi-party computation technique using the activation function.

16. An operating method of a deep learning system, comprising:
collecting data;
training a prediction model based on the collected data; and
performing a private inference using the prediction model,
wherein the private inference includes a homomorphic encryption operation and a multi-party computation, and
wherein the multi-party computation includes using an activation function including a Hermitic expansion using a Hermite polynomial as an eigenfunction to perform a Fourier transform.

17. The method of claim 16, wherein the collecting the data comprises generating a ciphertext using a homomorphic encryption scheme on plaintext data.

18. The method of claim 16, wherein the training the collected data comprises performing at least one of a feed-forward learning or a backpropagation learning.

19. The method of claim 16, wherein the performing the private inference comprises calculating a polynomial activation function using a Beaver Triple (BT) protocol.

20. The method of claim 16, wherein the performing the private inference comprises performing a convolution operation with respect to input values generated based on a homomorphic encryption scheme.

21. A deep learning system comprising:
an offline deep learning system; and
an online deep learning system,
wherein each of the offline deep learning system and the online deep learning system are trained to perform a convolution action, and to output operation values of the convolution action based on a polynomial activation function, and
wherein the polynomial activation function includes a Hermitic expansion using a Hermite polynomial as an eigenfunction to perform a Fourier transform.

22. The deep learning system of claim 21, wherein the offline deep learning system is configured to perform a convolution action on homomorphic encrypted input values.

23. The deep learning system of claim 21, wherein the online deep learning system is configured to perform a convolution action on plaintext input values.

24. The deep learning system of claim 21, wherein each of the offline deep learning system and the online deep learning system is configured to calculate the polynomial activation function based on a Beaver Triple (BT) protocol.

25. The deep learning system of claim 21, wherein the offline deep learning system comprises:
a client device configured to encrypt random data in a linear layer; and
a cloud server configured to generate an operated first result value by performing a first convolution operation on the random data received from the client device using a homomorphic encryption scheme, and to transmit the operated first result value to the client device.

26. The deep learning system of claim 25, wherein the online deep learning system comprises:
a client device configured to receive the operated first result value, the operated first result value having plaintext data and random data; and
a cloud server configured to generate a second result value by performing a second convolution operation, based on the homomorphic encryption scheme, on a subtracted value obtained by subtracting the random data from the plaintext data, and to transmit the second result value to the client device,
wherein the client device is configured to obtain an operation value for the plaintext data using the first result value and the second result value.
